(19) United States
(12) Patent Application Publication
(10) Pub. No.: US 2025/0380257 A1
(43) Pub. Date: Dec. 11, 2025

(54) DOWNLINK CONTROL INFORMATION DETECTION METHOD AND DEVICE, AND DOWNLINK CONTROL INFORMATION SENDING METHOD AND DEVICE

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/874,847

(22) PCT Filed: Jun. 17, 2022
(86) PCT No.: PCT/CN2022/099621

§ 371 Date: Dec. 13, 2024

(51) Int. Cl. H04W 72/1273; H04W 72/56

(52) U.S. Cl. CPC H04W 72/1273; H04W 72/56

(57) ABSTRACT

The present disclosure relates to a downlink control information (DCI) detection method and device, and a DCI sending method and device. The DCI detection method comprises: not expecting that, in a same time domain unit, the number of sizes of DCI that is scrambled by means of a first radio network temporary identifier (RNTI) and needs to be detected is greater than a first number, and the number of sizes of DCI that is scrambled by means of a second RNTI and needs to be detected is greater than a second number, wherein the DCI at least comprises DCI for scheduling a plurality of cells (S101).

### CROSS REFERENCE

The present application is a national phase application of International Application No. PCT/CN2022/099621, filed on Jun. 17, 2022, and the entire contents thereof are incorporated herein by reference.

### TECHNICAL FIELD

The present disclosure relates to the field of communication technology, and in particular to a downlink control information detection method, a downlink control information sending method, a downlink control information detection apparatus, a downlink control information sending apparatus, a communication device, and a computer-readable storage medium.

### BACKGROUND

In the related art, one downlink control information (DCI) is only used to schedule data of one cell, for example, scheduling the physical uplink shared channel (PUSCH) and physical downlink shared channel (PDSCH) of one cell.

With the fragmentation of frequency resources, the demand for scheduling data of multiple cells at the same time is gradually increasing. In order to reduce the control message overhead, it is proposed to schedule the data of multiple cells through a single DCI. For example, the DCI used to schedule multiple cells (data) can be called MC-DCI, where MC stands for multi-cell or multi-carrier.

As a newly introduced DCI, the MC-DCI may have a different format from the legacy DCI, and the size (size, the number of bits occupied) of the MC-DCI may also be different from the size of the legacy DCI.

It should be noted that, information disclosed in the above background portion is provided only for better understanding of the background of the present disclosure, and thus it may contain information that does not form the prior art known by those ordinary skilled in the art.

### SUMMARY

In view of this, the embodiments of the present disclosure propose a downlink control information detection method, a downlink control information sending method, a downlink control information detection apparatus, a downlink control information sending apparatus, a communication device and a computer-readable storage medium.

According to a first aspect of an embodiment of the present disclosure, a downlink control information detection method is proposed, which is executed by a terminal, and the method includes: not expecting that within a same time domain unit, a number of size of downlink control information DCI scrambled by a first radio network temporary identifier RNTI to be detected is greater than a first number, and a number of size of DCI scrambled by a second RNTI to be detected is greater than a second number; wherein the DCI at least includes DCI for scheduling multiple cells.

According to a second aspect of an embodiment of the present disclosure, a downlink control information detection method is proposed, which is executed by a terminal, and the method includes: determining that in a same time domain unit, a sum of a number of sizes of DCI for scheduling multiple cells and a number of sizes of DCI scrambled by a first RNTI to be detected is greater than a first number; wherein the DCI at least includes the DCI for scheduling multiple cells: determining a first DCI among the DCI to be detected; and not detecting DCI in a search space corresponding to the first DCI.

According to a third aspect of an embodiment of the present disclosure, a downlink control information sending method is proposed, which is executed by a network device, and the method includes: within a same time domain unit, a number of size of downlink control information DCI scrambled by a first radio network temporary identifier RNTI sent to a terminal is equal to or smaller than a first number, and a number of size of DCI scrambled by a second RNTI sent to the terminal is equal to or smaller than a second number: wherein the DCI at least includes DCI for scheduling multiple cells.

According to a fourth aspect of an embodiment of the present disclosure, a downlink control information sending method is proposed, which is executed by a network device, and the method includes: determining that in a same time domain unit, a sum of a number of sizes of DCI for scheduling multiple cells to be sent to a terminal and a number of sizes of DCI scrambled by a first RNTI is greater than a first number: wherein the DCI at least includes the DCI for scheduling multiple cells: determining a first DCI among the DCI to be sent; and not sending DCI in a search space corresponding to the first DCI.

According to a fifth aspect of an embodiment of the present disclosure, a downlink control information detection apparatus is provided, including: a processing module, configured to not expect that within a same time domain unit, a number of size of downlink control information scrambled by a first radio network temporary identifier RNTI to be detected is greater than a first number, and a number of size of DCI scrambled by a second RNTI to be detected is greater than a second number; wherein the DCI at least includes DCI for scheduling multiple cells.

According to a sixth aspect of an embodiment of the present disclosure, a downlink control information detection apparatus is provided, including: a processing module, configured to determine that in a same time domain unit, a sum of a number of sizes of DCI for scheduling multiple cells and a number of sizes of DCI scrambled by a first RNTI to be detected is greater than a first number: wherein the DCI at least includes the DCI for scheduling multiple cells; and determine a first DCI among the DCI to be detected; and a receiving module, configured to not detect DCI in a search space corresponding to the first DCI.

According to a seventh aspect of an embodiment of the present disclosure, a downlink control information sending apparatus is provided, including: a processing module, configured to: within a same time domain unit, a number of size of downlink control information scrambled by a first radio network temporary identifier RNTI sent to a terminal is equal to or smaller than a first number, and a number of size of DCI scrambled by a second RNTI sent to the terminal is equal to or smaller than a second number; wherein the DCI at least includes DCI for scheduling multiple cells.

According to an eighth aspect of an embodiment of the present disclosure, a downlink control information sending apparatus is provided, including: a processing module, configured to determine that in a same time domain unit, a sum of a number of sizes of DCI for scheduling multiple cells to be sent to a terminal and a number of sizes of DCI scrambled by a first RNTI is greater than a first number; wherein the DCI at least includes the DCI for scheduling multiple cells; and determine a first DCI among the DCI to be sent; and a sending module, configured to not send DCI in a search space corresponding to the first DCI.

According to a ninth aspect of an embodiment of the present disclosure, a communication device is provided, including: a processor; and a memory for storing a computer program: wherein when the computer program is executed by the processor, the above method for detecting downlink control information is implemented.

According to a tenth aspect of an embodiment of the present disclosure, a communication device is provided, including: a processor; and a memory for storing a computer program: wherein when the computer program is executed by the processor, the above method for sending downlink control information is implemented.

According to an eleventh aspect of an embodiment of the present disclosure, a computer readable storage medium is provided, which is configured to store a computer program, wherein when the computer program is executed by a processor, steps of the above method for detecting downlink control information are implemented.

According to a twelfth aspect of an embodiment of the present disclosure, a computer readable storage medium is provided, which is configured to store a computer program, wherein when the computer program is executed by a processor, steps of the above method for sending downlink control information are implemented.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present disclosure, the drawings required for use in the description of the embodiments will be briefly introduced below. Obviously, the drawings described below are only some embodiments of the present disclosure. For ordinary technicians in this field, other drawings can be obtained based on these drawings without creative effort.

FIG. 1 is a schematic flow chart of a downlink control information detection method according to an embodiment of the present disclosure.

FIG. 2A is a schematic flow chart of another downlink control information detection method according to an embodiment of the present disclosure.

FIG. 2B is a schematic diagram of an application scenario of a downlink control information detection method according to an embodiment of the present disclosure.

FIG. 3A is a schematic flow chart of another downlink control information detection method according to an embodiment of the present disclosure.

FIG. 3B is a schematic diagram of an application scenario of a downlink control information detection method according to an embodiment of the present disclosure.

FIG. 4 is a schematic flow chart of a method for detecting downlink control information according to an embodiment of the present disclosure.

FIG. 5 is a schematic flow chart of another downlink control information detection method according to an embodiment of the present disclosure.

FIG. 6 is a schematic diagram of an application scenario of a method for detecting downlink control information according to an embodiment of the present disclosure.

FIG. 7 is a schematic flow chart of yet another downlink control information detection method according to an embodiment of the present disclosure.

FIG. 8 is a schematic flow chart of a method for sending downlink control information according to an embodiment of the present disclosure.

FIG. 9 is a schematic flowchart of a method for sending downlink control information according to an embodiment of the present disclosure.

FIG. 10 is a schematic block diagram of a downlink control information detection apparatus according to an embodiment of the present disclosure.

FIG. 11 is a schematic block diagram of a downlink control information detection apparatus according to an embodiment of the present disclosure.

FIG. 12 is a schematic block diagram of an apparatus for sending downlink control information according to an embodiment of the present disclosure.

FIG. 13 is a schematic block diagram of an apparatus for sending downlink control information according to an embodiment of the present disclosure.

FIG. 14 is a schematic block diagram of an apparatus for sending downlink control information according to an embodiment of the present disclosure.

FIG. 15 is a schematic block diagram of an apparatus for detecting downlink control information according to an embodiment of the present disclosure.

### DETAILED DESCRIPTION

The technical implementations in the embodiments of the present disclosure will be described clearly and completely below in conjunction with the accompanying drawings in the embodiments of the present disclosure. Obviously, the described embodiments are only part of the embodiments of the present disclosure, not all of the embodiments. All other embodiments obtained by ordinary technicians in the art based on the embodiments of the present disclosure without creative effort are within the scope of protection of the present disclosure.

The terms used in the embodiments of the present disclosure are for the purpose of describing specific embodiments only and are not intended to limit the embodiments of the present disclosure. The singular forms “a”, “an” and “the” used in the embodiments of the present disclosure and the appended claims are also intended to include the plural forms unless the context clearly indicates otherwise. It should also be understood that the term “and/or” as used herein refers to and includes any and all possible combinations of one or more of the associated listed items.

It should be understood that although the terms first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to determining”.

For the purpose of brevity and ease of understanding, the terms used in this article to characterize size relationships are “greater than”, “less than”, “higher than” or “lower than”. However, it is understood by those skilled in the art that the term “greater than” also covers the meaning of “greater than or equal to”, and the term “less than” also covers the meaning of “less than or equal to”, the term “higher than” covers the meaning of “higher than or equal to”, and the term “lower than” also covers the meaning of “lower than or equal to”.

In one embodiment, after the introduction of DCI for scheduling multiple cells (for example, scheduling data of 3, 4, or 8 serving cells), the DCI for scheduling multiple cells may be referred to as MC-DCI, where MC stands for multi-cell or multi-carrier. Since MC-DCI is a newly introduced DCI, the size (abbreviation of payload size, i.e., the number of occupied bits) of MC-DCI may be different from that of legacy DCI (the format may also be different), which may result in an increase in the total number of DCI sizes.

Since the terminal receives DCI by blind decoding (BD) of PDCCH, and the maximum number of blind detections in the same time domain unit is fixed, these blind detections can be assigned to each size of DCI in the same time domain unit. Currently, in a serving cell, the sizes of DCI supported by the terminal meet the “3+1” requirement, that is, the number of sizes of DCIs scrambled by the Cell-Radio Network Temporary Identity (C-RNTI) is less than or equal to 3, and the number of sizes of DCIs scrambled by other RNTIs is less than or equal to 1.

However, due to the introduction of MC-DCI, the size of MC-DCI can be different from that of legacy DCI, which will increase the number of DCI sizes and reduce the number of blind detections (average number) assigned to the DCI of each size. The lower the number of blind detections, the worse the DCI parsing effect, which will affect the flexibility and performance of physical downlink control channel transmission.

In this case, the legacy DCI includes but is not limited to DCI used for scheduling a single cell, such as DCI format 0_0, DCI format 1_0, DCI format 0_1, DCI format 1_1, DCI format 0_2, DCI format 1_2. The format of MC-DCI may be different from the format of legacy DCI. For example, MC-DCI includes DCI format 0_3, DCI format 1_3.

The following embodiments mainly provide exemplary descriptions of two downlink control information detection methods, each of which can overcome the above technical problems.

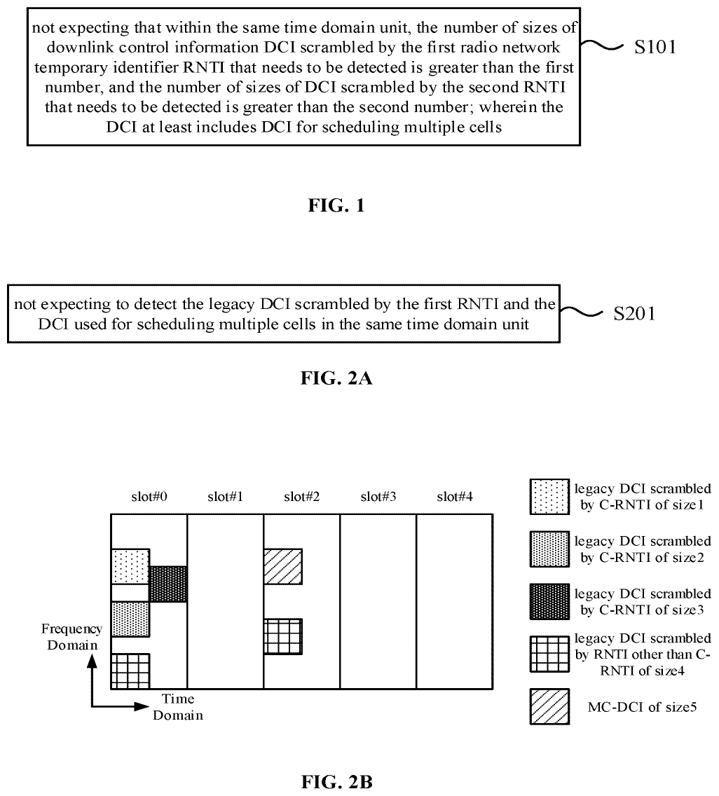

FIG. 1 is a schematic flow chart of a downlink control information detection method according to an embodiment of the present disclosure. The downlink control information detection method shown in this embodiment can be executed by a terminal, and the terminal includes but is not limited to a communication device such as a mobile phone, a tablet computer, a wearable device, a sensor, an Internet of Things device, etc. The terminal can communicate with a network device, and the network device includes but is not limited to a network device in a 4G, 5G, 6G, etc. communication system, such as a base station, a core network, etc.

As shown in FIG. 1, the downlink control information detection method may include the following steps:

In step S101, it is not expected that within the same time domain unit, the number of sizes of downlink control information DCI scrambled by the first radio network temporary identifier RNTI that needs to be detected is greater than the first number, and the number of sizes of DCI scrambled by the second RNTI that needs to be detected is greater than the second number.

In the embodiment, the DCI (the DCI scrambled by the first RNTI or the DCI scrambled by the second RNTI) at least includes DCI for scheduling multiple cells.

In one embodiment, when the network device includes MC-DCI in the DCI sent to the terminal, the network device can reasonably configure the DCI scrambled by the first RNTI and the DCI scrambled by the second RNTI so that within the same time domain unit, the number of sizes of DCIs scrambled by the first RNTI and sent to the terminal is less than or equal to the first number, and the number of sizes of DCIs scrambled by the second RNTI is less than or equal to the second number.

Correspondingly, the terminal may not expect that within the same time domain unit, the number of sizes of downlink control information scrambled by the first RNTI to be detected is greater than the first number, and the number of sizes of DCI scrambled by the second RNTI to be detected is greater than the second number. For example, if the first number is 3 and the second number is 1, it can be ensured that the “3+1” requirement is met.

Accordingly, it is possible to avoid having too many sizes of DCI scrambled by the first RNTI and too many sizes of DCI scrambled by the second RNTI in the same time domain unit, thereby ensuring that the number of blind detections (average number) assigned to DCI of each size will not decrease, ensuring a good parsing effect for DCI, and avoiding affecting the flexibility and performance of physical downlink control channel transmission.

In one embodiment, the time domain unit includes at least one of the following: a time slot, a time span, or a symbol.

In one embodiment, the first RNTI includes at least a C-RNTI, and the second RNTI includes a RNTI other than the C-RNTI.

In one embodiment, the first number is 3 or 4, and the second number is 1. The embodiments of the present disclosure are mainly described exemplarily when the first number is 3.

FIG. 2A is a schematic flow chart of another downlink control information detection method according to an embodiment of the present disclosure. As shown in FIG. 2A, it is not expected that within the same time domain unit, the number of sizes of downlink control information DCI scrambled by the first radio network temporary identifier RNTI to be detected is greater than the first number, and the number of sizes of DCI scrambled by the second RNTI to be detected is greater than the second number, including:

In step S201, it is not expected to detect the legacy DCI scrambled by the first RNTI and the DCI used for scheduling multiple cells in the same time domain unit.

In one embodiment, when the network device includes MC-DCI in the DCI sent to the terminal, the MC-DCI and the legacy DCI scrambled by the first RNTI may be set to be sent in different time domain units, that is, in the same time domain unit, only MC-DCI and the legacy DCI scrambled by the second RNTI are sent to the terminal, or only the legacy DCI scrambled by the first RNTI and the legacy DCI scrambled by the second RNTI are sent to the terminal. The transmission mode of MC-DCI and the legacy DCI scrambled by the first RNTI may be time division multiplexing (TDM).

Correspondingly, the terminal does not expect to detect the legacy DCI and MC-DCI scrambled by the first RNTI in the same time domain unit, that is, the terminal only expects to receive the legacy DCI scrambled by the first RNTI and the legacy DCI scrambled by the second RNTI, or to receive the MC-DCI and the legacy DCI scrambled by second RNTI in the same time domain unit.

Accordingly, in the same time domain unit, MC-DCI and legacy DCI scrambled by the first RNTI will not exist at the same time, so the number of DCI sizes in the same time domain unit will not increase relative to the related technology. For example, the “3+1” requirement can still be met. Then, in the same time domain unit, the number of DCI sizes scrambled by the first RNTI that need to be detected is less than or equal to the first number, and the number of DCI sizes that need to be scrambled by the second RNTI is less than or equal to the second number.

FIG. 2B is a schematic diagram of an application scenario of a downlink control information detection method according to an embodiment of the present disclosure.

As shown in FIG. 2B, the time domain unit is a time slot. Among the five slots (slot #0, slot #1, slot #2, slot #3, and slot #4), the network device sends DCI to the terminal in slot #0 and slot #2.

The network equipment can send MC-DCI and legacy DCI scrambled by C-RNTI in different slots through reasonable configuration. For example, 3 legacy DCI scrambled by C-RNTI and 1 legacy DCI scrambled by RNTI other than C-RNTI are sent to the terminal in slot #0. For example, the sizes of legacy DCI scrambled by C-RNTI are size1, size2 and size3, the size of legacy DCI scrambled by RNTI other than C-RNTI is size4, and the size of MC-DCI is size5.

In slot #2, one MC-DCI (which can be scrambled by C-RNTI or other RNTI) and one legacy DCI scrambled by another RNTI other than C-RNTI are sent to the terminal. For example, the size of the legacy DCI scrambled by another RNTI other than C-RNTI is size4, and the size of the MC-DCI is size5.

Based on this, it can be ensured that the number of DCI sizes in slot #0 and slot #2 meets the “3+1” requirement, and the terminal does not expect to detect the MC-DCI and the legacy DCI scrambled by the first RNTI in slot #0, nor does it expect to detect the MC-DCI and the legacy DCI scrambled by the first RNTI in slot #2.

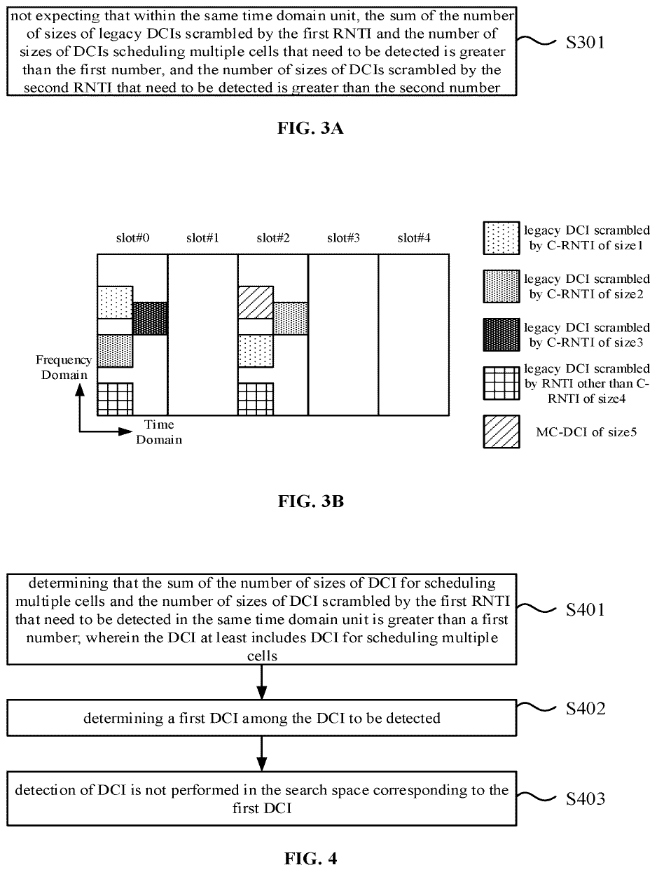

FIG. 3A is a schematic flow chart of another downlink control information detection method according to an embodiment of the present disclosure. As shown in FIG. 3A, it is not expected that within the same time domain unit, the number of sizes of downlink control information DCI scrambled by the first radio network temporary identifier RNTI to be detected is greater than the first number, and the number of sizes of DCI scrambled by the second RNTI to be detected is greater than the second number, including:

In step S301, it is not expected that within the same time domain unit, the sum of the number of sizes of legacy DCIs scrambled by the first RNTI and the number of sizes of DCIs scheduling multiple cells that need to be detected is greater than the first number, and the number of sizes of DCIs scrambled by the second RNTI that need to be detected is greater than the second number.

In one embodiment, when the network device includes MC-DCI in the DCI sent to the terminal, the network device may send MC-DCI and legacy DCI scrambled by the first RNTI in the same time domain unit. In this case, reasonable configuration may be performed so that, in the same time domain unit, the sum of the number of sizes of MC-DCI and the number of sizes of legacy DCI scrambled by the first RNTI is less than or equal to the first number, and the number of sizes of DCI scrambled by the second RNTI is less than or equal to the second number.

Correspondingly, the terminal does not expect that within the same time domain unit, the sum of the number of sizes of MC-DCI and the number of sizes of legacy DCI scrambled by the first RNTI to be detected is greater than the first number, and the number of DCI sizes to be detected scrambled by the second RNTI is greater than the second number.

Accordingly, the number of DCI sizes scrambled by the first RNTI that need to be detected in the same time domain unit is less than or equal to the first number, and the number of DCI sizes scrambled by the second RNTI that need to be detected is less than or equal to the second number, for example, the “3+1” requirement can still be met.

FIG. 3B is a schematic diagram of an application scenario of a downlink control information detection method according to an embodiment of the present disclosure.

As shown in FIG. 3B, the time domain unit is a time slot. Among the five slots (slot #0, slot #1, slot #2, slot #3, and slot #4), the network device sends DCI to the terminal in slot #0 and slot #2.

When MC-DCI and legacy DCI scrambled by the first RNTI are sent in the same time domain unit, the network device is reasonably configured so that in the same time domain unit, the sum of the number of sizes of MC-DCI and the number of sizes of legacy DCI scrambled by the first RNTI is less than or equal to the first number, and the number of DCI sizes scrambled by the second RNTI is less than or equal to the second number.

For example, in slot #0, three legacy DCIs scrambled by C-RNTI and one DCI scrambled by an RNTI other than C-RNTI are sent to the terminal. For example, the sizes of the legacy DCIs scrambled by C-RNTI are size1, size2, and size3, respectively, and the size of the legacy DCI scrambled by an RNTI other than C-RNTI is size4.

In slot #2, one MC-DCI (which can be scrambled by C-RNTI or other RNTI), two legacy DCIs scrambled by C-RNTI, and one legacy DCI scrambled by RNTI other than C-RNTI are sent to the terminal. For example, the sizes of the legacy DCI scrambled by C-RNTI are size1 and size2, the size of the legacy DCI scrambled by RNTI other than C-RNTI is size4, and the size of the MC-DCI is size5.

Accordingly, although MC-DCI and legacy DCI scrambled by C-RNTI are sent in slot #2, it can still be ensured that the sizes of the MC-DCI and the legacy DCI scrambled by C-RNTI is less than or equal to 3, thereby ensuring that the number of DCI sizes in slot #0 and slot #2 meets the “3+1” requirement. The terminal does not expect that the sum of the number of sizes of MC-DCI and the number of sizes of legacy DCI scrambled by the first RNTI that need to be detected in slot #0 and slot #2 is greater than the first number, and the number of sizes of legacy DCI scrambled by the second RNTI that need to be detected is greater than the second number.

FIG. 4 is a schematic flow chart of a downlink control information detection method according to an embodiment of the present disclosure. The downlink control information detection method shown in this embodiment can be executed by a terminal, and the terminal includes but is not limited to a communication device such as a mobile phone, a tablet computer, a wearable device, a sensor, an Internet of Things device, etc. The terminal can communicate with a network device, and the network device includes but is not limited to a network device in a 4G, 5G, 6G, etc. communication system, such as a base station, a core network, etc.

As shown in FIG. 4, the downlink control information detection method may include the following steps:

In step S401, it is determined that the sum of the number of sizes of DCIs for scheduling multiple cells and the number of sizes of DCIs scrambled by the first RNTI that need to be detected in the same time domain unit is greater than a first number; wherein the DCI at least includes DCIs for scheduling multiple cells:

In step S402, a first DCI is determined among the DCIs to be detected (i.e., the MC-DCI and the DCI scrambled by the first RNTI);

In step S403, detection of DCI is not performed in the search space corresponding to the first DCI.

In one embodiment, when the network device includes MC-DCI in the DCI sent to the terminal, the network device can determine the sum of the number of sizes of MC-DCI and the number of DCI sizes scrambled by the first RNTI that need to be sent to the terminal in the same time domain unit. When the sum of the numbers is greater than the first number, the network device can determine the first DCI among the DCI that needs to be sent, and then not send the DCI to the terminal in the search space (SS) corresponding to the first DCI. How to determine the first DCI will be described in subsequent embodiments.

Correspondingly, the terminal can determine the sum of the number of sizes of MC-DCI and the number of DCI sizes scrambled by the first RNTI that need to be detected sent by the network device (in a service cell) in the same time domain unit. When the sum of the numbers is greater than the first number, the terminal can determine the first DCI in the DCI that needs to be received, and then not monitor the DCI in the SS corresponding to the first DCI.

Based on this, the number of DCI sizes in the same time domain unit can be reduced. For example, if the first number is 3, then within the same time domain unit, the number of sizes of MC-DCI and the number of sizes of legacy DCI scrambled by the first RNTI that the terminal expects to monitor are less than or equal to 3, ensuring that the “3+1” requirement is met.

According to the embodiments of the present disclosure, it is possible to avoid the sum of the number of sizes of MC-DCI and the number of sizes of legacy DCI scrambled by the first RNTI within the same time domain unit being too large, thereby ensuring that the number of blind detections (average number) assigned to DCI of each size will not decrease, ensuring a good parsing effect for DCI, and avoiding affecting the flexibility and performance of physical downlink control channel transmission.

In one embodiment, the time domain unit includes at least one of the following:

A time slot, a time span, or a symbol.

In one embodiment, the first RNTI includes at least a C-RNTI.

In one embodiment, the first number is 3 or 4.

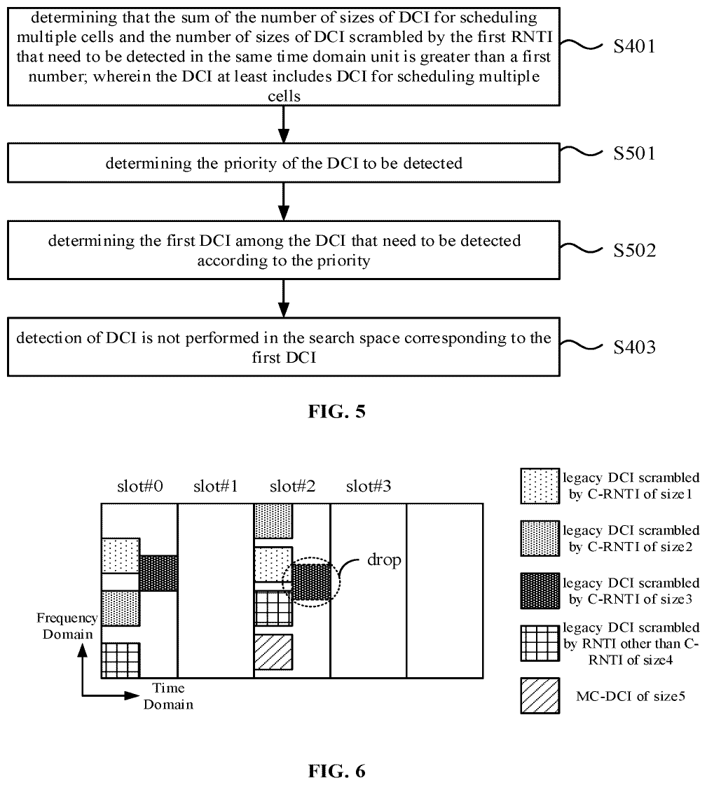

FIG. 5 is a schematic flow chart of another downlink control information detection method according to an embodiment of the present disclosure. As shown in FIG. 5, determining the first DCI among the DCI to be detected includes:

In step 501, the priority of the DCI to be detected is determined:

In step 502, the first DCI is determined among the DCI that need to be detected according to the priority.

In one embodiment, the network device can determine the priority of the DCI sent to the terminal, and then determine the first DCI in the DCI that needs to be detected according to the priority, for example, determining the DCI with the lowest priority as the first DCI, so that the DCI is not sent in the SS corresponding to the first DCI, that is, the first DCI is not sent.

Correspondingly, the terminal can determine the priority of the DCI that needs to be detected, and then determine the first DCI among the DCI that needs to be detected according to the priority. The way in which the terminal determines the first DCI is the same as the way in which the network device determines the first DCI, so that the same first DCI can be determined as the network device does, that is, the network device does not send the first DCI, and the terminal does not receive the first DCI. Accordingly, it can avoid affecting the high-priority DCI and ensure that the high-priority DCI can be sent and received smoothly.

It should be noted that the priorities involved in all embodiments of the present disclosure may be agreed upon by the protocol or indicated by the network device, for example, the network device indicates through a Radio Resource Control (RRC) message. The priority may be related to the parameters of the service corresponding to the DCI, for example, the lower the latency required by the service, the higher the priority, and the higher the quality of service required by the service, the higher the priority.

In one embodiment, determining the first DCI among the DCI that needs to be detected according to the priority includes: determining the difference between the sum of the numbers and the first number; determining the difference number of DCI among the DCI that needs to be detected as the first DCI, wherein the priority of each DCI in the difference number of DCI is lower than the priority of other DCI in the DCI that needs to be detected.

Since the number of sizes of MC-DCI and the number of sizes of legacy DCI scrambled by the first RNTI that the network device needs to send to the terminal may be large, for example, exceeding the first number by more than 1. In order to ensure that the sum of the number of sizes of MC-DCI and the number of sizes of legacy DCI scrambled by the first RNTI in the same time domain unit is less than or equal to the first number, the determined number of first DCIs may be equal to 1 or greater than 1.

For example, the difference between the sum of the numbers and the first number can be determined, and then the difference number of DCI is determined as the first DCI among the DCI to be detected, and the priority of the determined first DCI is lower than the priority of other DCI in the DCI to be detected. Accordingly, it is possible to avoid affecting the high-priority DCI and ensure that the high-priority DCI can be sent and received smoothly.

FIG. 6 is a schematic diagram of an application scenario of a method for detecting downlink control information according to an embodiment of the present disclosure.

As shown in FIG. 6, the time domain unit is a time slot. Among five slots (slot #0, slot #1, slot #2, slot #3, and slot #4), the network device sends DCI to the terminal in slot #0 and slot #2.

For example, in slot #0, three legacy DCI scrambled by C-RNTI and one DCI scrambled by RNTI other than C-RNTI need to be sent to the terminal. For example, the sizes of the legacy DCI scrambled by C-RNTI are size1, size2, and size3, respectively, and the size of the legacy DCI scrambled by RNTI other than C-RNTI is size4.

In slot #2, one MC-DCI (which can be scrambled by C-RNTI or other RNTI), three legacy DCI scrambled by C-RNTI, and one legacy DCI scrambled by RNTI other than C-RNTI need to be sent to the terminal. For example, the sizes of the legacy DCI scrambled by C-RNTI are size1, size2 and size3, the size of the legacy DCI scrambled by RNTI other than C-RNTI is size4, and the size of the MC-DCI is size5.

In this case, the sum of the number of sizes of MC-DCI and the number of sizes of legacy DCI scrambled by C-RNTI that need to be sent to the terminal in slot #2 is 4, which is greater than the first number 3. The difference between the sum of the numbers and the first number is calculated to be 4−3=1, which means that 1 first DCI can be determined.

Specifically, the DCI with the lowest priority among the MC-DCI and the three legacy DCI scrambled by the C-RNTI can be determined as the first DCI. For example, the DCI with a size of size3 can be determined as the first DCI. Then, in the SS corresponding to the first DCI, the network device does not send the DCI, and the terminal does not detect the DCI. This situation can also be referred to as dropping the first DCI.

FIG. 7 is a schematic flow chart of another downlink control information detection method according to an embodiment of the present disclosure. As shown in FIG. 7, determining the first DCI among the DCI to be detected according to the priority includes:

In step S701, the priority of the search space SS (which may also be replaced by the control resource set CORESET) corresponding to the DCI to be detected is determined:

In step S702, a first SS is determined among the SSs corresponding to the DCI that need to be detected according to the priority, wherein the DCI corresponding to the first SS is the first DCI.

In one embodiment, the network device can determine the priority of the SS corresponding to the DCI sent to the terminal, and then determine the first SS among the SSs corresponding to the DCI that needs to be detected according to the priority. For example, the SS with the lowest priority is determined as the first SS, and the DCI corresponding to the first SS is determined to be the first DCI. In this case, the DCI is not sent in the first SS, that is, the first DCI is not sent.

Correspondingly, the terminal can determine the priority of the SS corresponding to the DCI that needs to be detected, and then determine the first SS among the SSs corresponding to the DCI that needs to be detected according to the priority. The way in which the terminal determines the first SS is the same as the way in which the network device determines the first SS, so that the same first SS can be determined as the network device does, that is, the network device does not send the first DCI in the first SS, and the terminal does not receive the first DCI in the first SS. Accordingly, it can avoid affecting the DCI in the high-priority SS, ensuring that the DCI in the high-priority SS can be sent and received smoothly.

In one embodiment, determining the first SS among the SSs corresponding to the DCI that needs to be detected according to the priority includes: determining the difference number between the sum of the numbers and the first number: determining the difference number of SSs among the SSs corresponding to the DCI that needs to be detected as the first SS, wherein the priority of each SS in the difference number of SSs is lower than the priority of other SSs in the SSs corresponding to the DCI that needs to be detected.

Since the number of sizes of MC-DCI and the number of sizes of legacy DCI scrambled by the first RNTI that the network device needs to send to the terminal may be large, for example, exceeding the first number by more than 1. In order to ensure that the sum of the number of sizes of MC-DCI and the number of sizes of legacy DCI scrambled by the first RNTI in the same time domain unit is less than or equal to the first number, the determined number of first DCIs may be equal to 1 or greater than 1.

For example, the difference between the sum of the numbers and the first number can be determined, and then the difference number of SSs are determined as the first SS among the SSs corresponding to the DCI to be detected, and the priority of the determined first SS is lower than the priority of other SSs in the SS corresponding to the DCI to be detected. Accordingly, it is possible to avoid affecting the DCI in the high-priority SS and ensure that the DCI in the high-priority SS can be sent and received smoothly.

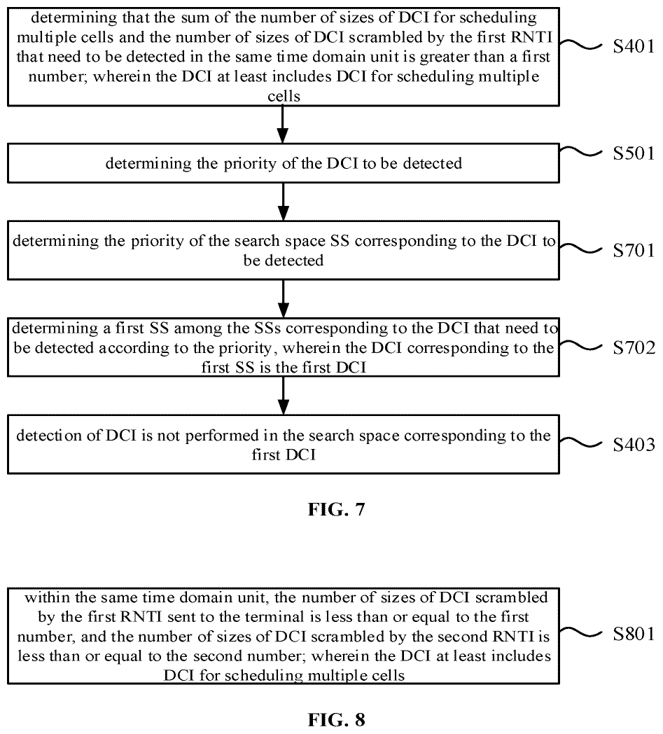

FIG. 8 is a schematic flow chart of a method for sending downlink control information according to an embodiment of the present disclosure. The method for sending downlink control information shown in this embodiment can be executed by a network device, and the network device can communicate with a terminal, and the network device includes but is not limited to a base station in a communication system such as a 4G base station, a 5G base station, and a 6G base station, and the terminal includes but is not limited to a mobile phone, a tablet computer, a wearable device, a sensor, an Internet of Things device, and other communication devices.

As shown in FIG. 8, the method for sending downlink control information may include the following steps:

In step S801, within the same time domain unit, the number of sizes of downlink control information DCI scrambled by the first wireless network temporary identifier RNTI sent to the terminal is less than or equal to the first number, and the number of sizes of DCI scrambled by the second RNTI is less than or equal to the second number; wherein the DCI at least includes DCI for scheduling multiple cells.

In one embodiment, when the network device includes MC-DCI in the DCI sent to the terminal, the network device can reasonably configure the DCI scrambled by the first RNTI and the DCI scrambled by the second RNTI so that within the same time domain unit, the number of sizes of DCI scrambled by the first RNTI sent to the terminal is less than or equal to the first number, and the number of sizes of DCI scrambled by the second RNTI is less than or equal to the second number.

Correspondingly, the terminal may not expect that within the same time domain unit, the number of sizes of downlink control information scrambled by the first RNTI to be detected is greater than the first number, and the number of sizes of DCI scrambled by the second RNTI to be detected is greater than the second number. For example, if the first number is 3 and the second number is 1, it can be ensured that the “3+1” requirement is met.

Accordingly, it is possible to avoid excessive numbers of DCI sizes scrambled by the first RNTI and DCI sizes scrambled by the second RNTI in the same time domain unit, thereby ensuring that the number of blind detections (average number) assigned to DCI of each size will not decrease, ensuring a good parsing effect for DCI, and avoiding affecting the flexibility and performance of physical downlink control channel transmission.

In one embodiment, the time domain unit includes at least one of the following: A time slot, a time span, or a symbol.

In one embodiment, the first RNTI includes at least a C-RNTI, and the second RNTI includes a RNTI other than the C-RNTI.

In one embodiment, the first number is 3 or 4, and the second number is 1. The embodiments of the present disclosure are mainly described exemplarily when the first number is 3.

In one embodiment, within the same time domain unit, the number of sizes of downlink control information DCI scrambled by the first wireless network temporary identifier RNTI sent to the terminal is less than or equal to the first number, and the number of sizes of DCI scrambled by the second RNTI is less than or equal to the second number, including:

In the same time domain unit, the legacy DCI scrambled by the first RNTI or the DCI for scheduling multiple cells is sent to the terminal.

In one embodiment, when the network device includes MC-DCI in the DCI sent to the terminal, the MC-DCI and the legacy DCI scrambled by the first RNTI may be set to be sent in different time domain units, that is, in the same time domain unit, only MC-DCI and the legacy DCI scrambled by the second RNTI are sent to the terminal, or only the legacy DCI scrambled by the first RNTI and the legacy DCI scrambled by the second RNTI are sent to the terminal. The transmission method of MC-DCI and the legacy DCI scrambled by the first RNTI can be time division multiplexing TDM.

Correspondingly, the terminal does not expect to detect the legacy DCI and MC-DCI scrambled by the first RNTI in the same time domain unit, that is, the terminal only expects to receive the legacy DCI scrambled by the first RNTI and the legacy DCI scrambled by the second RNTI, or to receive the MC-DCI and the legacy DCI scrambled by second RNTI in the same time domain unit.

Accordingly, in the same time domain unit, MC-DCI and legacy DCI scrambled by the first RNTI will not exist at the same time, so the number of DCI sizes in the same time domain unit will not increase relative to the related technology. For example, the “3+1” requirement can still be met. Then, in the same time domain unit, the number of DCI sizes scrambled by the first RNTI that need to be detected is less than or equal to the first number, and the number of DCI sizes that need to be scrambled by the second RNTI is less than or equal to the second number.

In one embodiment, within the same time domain unit, the number of sizes of downlink control information DCI scrambled by the first wireless network temporary identifier RNTI sent to the terminal is less than or equal to the first number, and the number of sizes of DCI scrambled by the second RNTI is less than or equal to the second number, including:

Within the same time domain unit, the sum of the number of sizes of legacy DCI scrambled by the first RNTI sent to the terminal and the number of sizes of DCIs sent to the terminal for scheduling multiple cells is less than or equal to the first number, and the number of sizes of DCIs scrambled by the second RNTI sent to the terminal is less than or equal to the second number.

In one embodiment, when the network device includes MC-DCI in the DCI sent to the terminal, the network device may send MC-DCI and legacy DCI scrambled by the first RNTI in the same time domain unit. In this case, reasonable configuration may be performed so that, in the same time domain unit, the sum of the number of sizes of MC-DCI and the number of sizes of legacy DCI scrambled by the first RNTI is less than or equal to the first number, and the number of DCI sizes scrambled by the second RNTI is less than or equal to the second number.

Correspondingly, the terminal does not expect that within the same time domain unit, the sum of the number of sizes of MC-DCI and the number of sizes of legacy DCI scrambled by the first RNTI to be detected is greater than the first number, and the number of DCI sizes to be detected scrambled by the second RNTI is greater than the second number.

Accordingly, the number of DCI sizes scrambled by the first RNTI that need to be detected in the same time domain unit is less than or equal to the first number, and the number of DCI sizes scrambled by the second RNTI that need to be detected is less than or equal to the second number, for example, the “3+1” requirement can still be met.

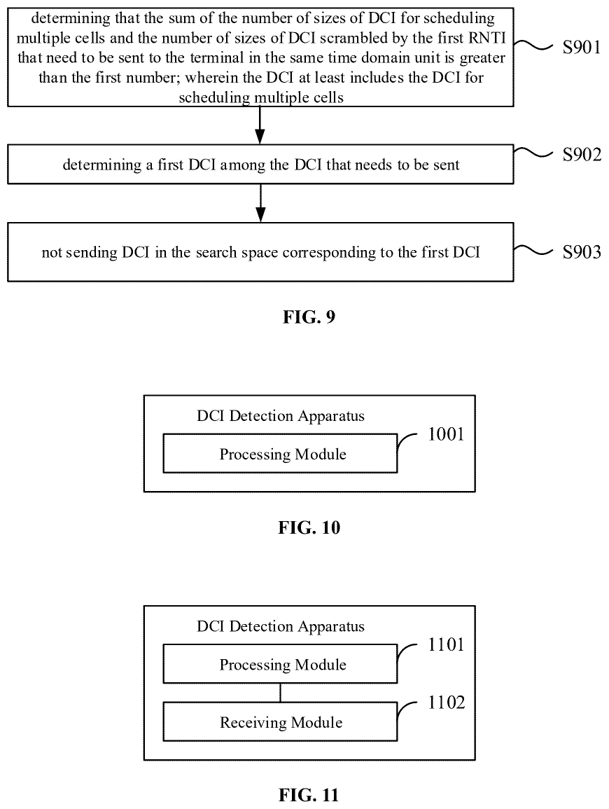

FIG. 9 is a schematic flow chart of a method for sending downlink control information according to an embodiment of the present disclosure. The method for sending downlink control information shown in this embodiment can be executed by a network device, and the network device can communicate with a terminal, the network device includes but is not limited to a base station in a communication system such as a 4G base station, a 5G base station, and a 6G base station, and the terminal includes but is not limited to a mobile phone, a tablet computer, a wearable device, a sensor, an Internet of Things device, and other communication devices.

As shown in FIG. 9, the method for sending downlink control information may include the following steps:

In step S901, it is determined that the sum of the number of sizes of DCI for scheduling multiple cells and the number of sizes of DCIs scrambled by the first RNTI that need to be sent to the terminal in the same time domain unit is greater than the first number; wherein the DCI at least includes the DCI for scheduling multiple cells:

In step S902, a first DCI is determined among the DCI that needs to be detected;

In step S903, the DCI is not sent in the search space corresponding to the first DCI.

In one embodiment, when the network device includes MC-DCI in the DCI sent to the terminal, the network device can determine the sum of the number of sizes of MC-DCI and the number of DCI sizes scrambled by the first RNTI that need to be sent to the terminal in the same time domain unit. When the sum of the numbers is greater than the first number, the network device can determine the first DCI among the DCI that needs to be sent, and then not send the DCI to the terminal in the search space (SS) corresponding to the first DCI. How to determine the first DCI will be described in subsequent embodiments.

Correspondingly, the terminal can determine the sum of the number of sizes of MC-DCI and the number of DCI sizes scrambled by the first RNTI that need to be detected sent by the network device (in a service cell) in the same time domain unit. When the sum of the numbers is greater than the first number, the terminal can determine the first DCI among the DCI that needs to be received, and then not monitor the DCI in the SS corresponding to the first DCI.

Based on this, the number of DCI sizes in the same time domain unit can be reduced. For example, if the first number is 3, then within the same time domain unit, the number of sizes of MC-DCI and the number of sizes of legacy DCI scrambled by the first RNTI that the terminal expects to monitor are less than or equal to 3, ensuring that the “3+1” requirement is met.

According to the embodiments of the present disclosure, it is possible to avoid the sum of the number of sizes of MC-DCI and the number of sizes of legacy DCI scrambled by the first RNTI within the same time domain unit being too large, thereby ensuring that the number of blind detections (average number) assigned to DCI of each size will not decrease, ensuring a good parsing effect for DCI, and avoiding affecting the flexibility and performance of physical downlink control channel transmission.

In one embodiment, the time domain unit includes at least one of the following:

A time slot, a time span, or a symbol.

In one embodiment, the first RNTI includes at least a C-RNTI.

In one embodiment, the first number is 3 or 4.

In one embodiment, determining the first DCI in the DCI that needs to be sent includes: determining a priority of the DCI that needs to be sent; and determining the first DCI in the DCI that needs to be sent according to the priority.

In one embodiment, the network device can determine the priority of the DCI to be sent to the terminal, and then determine the first DCI in the DCI that needs to be sent according to the priority, for example, determining the DCI with the lowest priority as the first DCI, so that the DCI is not sent in the SS corresponding to the first DCI, that is, the first DCI is not sent.

Correspondingly, the terminal can determine the priority of the DCI that needs to be detected, and then determine the first DCI in the DCI that needs to be detected according to the priority. The way in which the terminal determines the first DCI is the same as the way in which the network device determines the first DCI, so that the same first DCI can be determined as the network device does, that is, the network device does not send the first DCI, and the terminal does not receive the first DCI. Accordingly, it can avoid affecting the high-priority DCI and ensure that the high-priority DCI can be sent and received smoothly.

In one embodiment, determining the first DCI in the DCI that needs to be sent according to the priority includes: determining the difference between the sum of the numbers and the first number: determining the difference number of DCI among the DCI that needs to be sent as the first DCI, wherein the priority of each DCI in the difference number of DCI is lower than the priority of other DCI in the DCI that needs to be sent.

Since the number of sizes of MC-DCI and the number of sizes of legacy DCI scrambled by the first RNTI that the network device needs to send to the terminal may be large, for example, exceeding the first number by more than 1. In order to ensure that the sum of the number of sizes of MC-DCI and the number of sizes of legacy DCI scrambled by the first RNTI in the same time domain unit is less than or equal to the first number, the determined number of first DCIs may be equal to 1 or greater than 1.

For example, the difference between the sum of the numbers and the first number can be determined, and then the difference number of DCI is determined as the first DCI among the DCI to be sent, and the priority of the determined first DCI is lower than the priority of other DCI in the DCI to be sent. Accordingly, it is possible to avoid affecting the high-priority DCI and ensure that the high-priority DCI can be sent and received smoothly.

In one embodiment, determining the first DCI among the DCI that needs to be sent according to the priority includes: determining the priority of the search space SS corresponding to the DCI that needs to be sent: determining the first SS among the SSs corresponding to the DCI that needs to be sent according to the priority, wherein the DCI corresponding to the first SS is the first DCI.

In one embodiment, the network device can determine the priority of the SS corresponding to the DCI to be sent to the terminal, and then determine the first SS among the SSs corresponding to the DCI that needs to be sent according to the priority. For example, the SS with the lowest priority is determined as the first SS, and the DCI corresponding to the first SS is determined to be the first DCI. In this case, the DCI is not sent in the first SS, that is, the first DCI is not sent.

Correspondingly, the terminal can determine the priority of the SS corresponding to the DCI that needs to be detected, and then determine the first SS among the SSs corresponding to the DCI that needs to be detected according to the priority. The way in which the terminal determines the first SS is the same as the way in which the network device determines the first SS, so that the same first SS can be determined as the network device does, that is, the network device does not send the first DCI in the first SS, and the terminal does not receive the first DCI in the first SS. Accordingly, it can avoid affecting the DCI in the high-priority SS, ensuring that the DCI in the high-priority SS can be sent and received smoothly.

In one embodiment, determining the first SS among the SSs corresponding to the DCI that needs to be sent according to the priority includes: determining the difference number between the sum of the numbers and the first number; determining the difference number of SS among the SSs corresponding to the DCI that needs to be sent as the first SS, wherein the priority of each SS in the difference number of SSs is lower than the priority of other SSs in the SSs corresponding to the DCI that needs to be sent.

Since the number of sizes of MC-DCI and the number of sizes of legacy DCI scrambled by the first RNTI that the network device needs to send to the terminal may be large, for example, exceeding the first number by more than 1. In order to ensure that the sum of the number of sizes of MC-DCI and the number of sizes of legacy DCI scrambled by the first RNTI in the same time domain unit is less than or equal to the first number, the determined number of first DCIs may be equal to 1 or greater than 1.

For example, the difference between the sum of the numbers and the first number can be determined, and then the difference number of SS is determined as the first DCI among the SSs corresponding to the DCI to be sent, and the priority of the determined first SS is lower than the priority of other SS in the SSs corresponding to the DCI to be sent. Accordingly, it is possible to avoid affecting the DCI in the high-priority SS and ensure that the DCI in the high-priority SS can be sent and received smoothly.

Corresponding to the aforementioned embodiments of the downlink control information detection method and the downlink control information sending method, the present disclosure also provides embodiments of a downlink control information detection apparatus and a downlink control information sending apparatus.

FIG. 10 is a schematic block diagram of a downlink control information detection apparatus according to an embodiment of the present disclosure. The downlink control information detection apparatus shown in this embodiment may be a terminal, or a device including modules in a terminal, and the terminal includes but is not limited to a mobile phone, a tablet computer, a wearable device, a sensor, an Internet of Things device and other communication devices. The terminal may communicate with a network device, and the network device includes but is not limited to a network device in a 4G, 5G, 6G and other communication systems, such as a base station, a core network and the like.

As shown in FIG. 10, the downlink control information detection apparatus includes:

A processing module 1001, configured to not expect that within the same time domain unit, the number of sizes of downlink control information scrambled by the first wireless network temporary identifier RNTI that needs to be detected is greater than the first number, and the number of sizes of DCI scrambled by the second RNTI that needs to be detected is greater than the second number; wherein the DCI at least includes DCI for scheduling multiple cells.

In one embodiment, the processing module is configured to: not expect to detect the legacy DCI scrambled by the first RNTI and the DCI for scheduling multiple cells in a same time domain unit.

In one embodiment, the processing module is configured to not expect that within the same time domain unit, the sum of the number of sizes of legacy DCI scrambled by the first RNTI and the number of sizes of DCI used to schedule multiple cells that need to be detected is greater than the first number, and the number of sizes of DCI scrambled by the second RNTI that need to be detected is greater than the second number.

In one embodiment, the time domain unit includes at least one of the following:

A time slot, a time span, or a symbol.

In one embodiment, the first RNTI includes at least a cell radio network temporary identifier C-RNTI, and the second RNTI includes an RNTI other than the C-RNTI.

In one embodiment, the first number is 3 or 4, and the second number is 1.

FIG. 11 is a schematic block diagram of a downlink control information detection apparatus according to an embodiment of the present disclosure. The downlink control information detection apparatus shown in this embodiment may be a terminal, or a device including modules in a terminal, and the terminal includes but is not limited to a mobile phone, a tablet computer, a wearable device, a sensor, an Internet of Things device and other communication devices. The terminal may communicate with a network device, and the network device includes but is not limited to a network device in a 4G, 5G, 6G and other communication systems, such as a base station, a core network, etc.

As shown in FIG. 11, the downlink control information detection apparatus includes:

A processing module 1101, configured to determine that the sum of the number of sizes of DCIs for scheduling multiple cells and the number of sizes of DCIs scrambled by the first RNTI that need to be detected in the same time domain unit is greater than the first number: wherein the DCI at least includes DCI for scheduling multiple cells; and determine the first DCI among the DCI that need to be detected; and

A receiving module 1102, configured to: not to detect DCI in the search space corresponding to the first DCI.

In one embodiment, the processing module is configured to determine a priority of the DCI that needs to be detected; and determine the first DCI among the DCI that needs to be detected according to the priority.

In one embodiment, the processing module is configured to determine the difference between the sum of the numbers and the first number; and determine the difference number of DCI among the DCI that needs to be detected as the first DCI, wherein the priority of each DCI in the difference number of DCI is lower than the priority of other DCI in the DCI that needs to be detected.

In one embodiment, the processing module is configured to determine the priority of the search space SS corresponding to the DCI that needs to be detected; and determine the first SS among the SSs corresponding to the DCI that needs to be detected according to the priority, wherein the DCI corresponding to the first SS is the first DCI.

In one embodiment, the processing module is configured to determine the difference between the sum of the numbers and the first number; and determine the difference number of SS among the SSs corresponding to the DCI that needs to be detected as the first SS, wherein the priority of each SS in the difference number of SS has a lower priority than other SS in the SS corresponding to the DCI that needs to be detected.

In one embodiment, the time domain unit includes at least one of the following: A time slot, a time span, or a symbol.

In one embodiment, the first RNTI includes at least a cell radio network temporary identifier C-RNTI.

In one embodiment, the first number is 3 or 4.

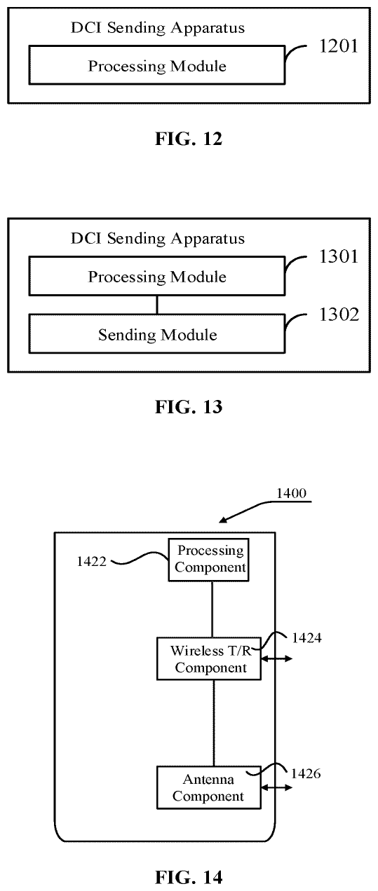

FIG. 12 is a schematic block diagram of a downlink control information sending apparatus according to an embodiment of the present disclosure. The downlink control information sending apparatus shown in this embodiment may be a network device, or a device including modules in a network device, and the network device may communicate with a terminal, and the terminal includes but is not limited to a mobile phone, a tablet computer, a wearable device, a sensor, an Internet of Things device and other communication devices. The network device includes but is not limited to a network device in a 4G, 5G, 6G and other communication systems, such as a base station, a core network, etc.

As shown in FIG. 12, the downlink control information sending apparatus includes:

a processing module 1201, configured to: configured to: within a same time domain unit, a number of sizes of downlink control information scrambled by a first radio network temporary identifier RNTI sent to a terminal is equal to or smaller than a first number, and a number of sizes of DCI scrambled by a second RNTI sent to the terminal is equal to or smaller than a second number: wherein the DCI at least comprises DCI for scheduling multiple cells.

In one embodiment, the processing module is configured to send, within a same time domain unit, to the terminal a legacy DCI scrambled by the first RNTI or the DCI for scheduling multiple cells.

In one embodiment, the processing module is configured such that, within the same time domain unit, the sum of the number of sizes of legacy DCIs scrambled by the first RNTI and the number of sizes of DCIs for scheduling multiple cells sent to the terminal is less than or equal to a first number, and the number of sizes of DCIs scrambled by the second RNTI and sent to the terminal is less than or equal to a second number.

FIG. 13 is a schematic block diagram of a downlink control information sending apparatus according to an embodiment of the present disclosure. The downlink control information sending apparatus shown in this embodiment may be a network device, or a device including modules in a network device, and the network device may communicate with a terminal, and the terminal includes but is not limited to a mobile phone, a tablet computer, a wearable device, a sensor, an Internet of Things device and other communication devices. The network device includes but is not limited to a network device in a 4G, 5G, 6G and other communication systems, such as a base station, a core network and the like.

As shown in FIG. 13, the downlink control information sending apparatus includes:

a processing module 1301, is configured to determine that the sum of the number of sizes of DCI for scheduling multiple cells and the number of sizes of DCI scrambled by the first RNTI that need to be sent to the terminal in the same time domain unit is greater than the first number; wherein the DCI at least includes the DCI for scheduling multiple cells; and determine the first DCI in the DCI that needs to be detected; and

a sending module 1302, configured not to send DCI in the search space corresponding to the first DCI.

In one embodiment, the processing module is configured to determine a priority of the DCI that needs to be sent; and determine the first DCI in the DCI that needs to be sent according to the priority.

In one embodiment, the processing module is configured to determine the difference between the sum of the numbers and the first number; and determine a difference number of DCI among the DCI that needs to be sent as the first DCI, wherein the priority of each DCI in the difference number of DCI is lower than the priority of other DCIs in the DCI that needs to be sent.

In one embodiment, the processing module is configured to determine the priority of the search space SSs corresponding to the DCI that needs to be sent; and determine the first SS among the SSs corresponding to the DCI that needs to be sent according to the priority, wherein the DCI corresponding to the first SS is the first DCI.

In one embodiment, the processing module is configured to determine the difference between the sum of the numbers and the first number; and determine a difference number of SS among the SSs corresponding to the DCI that needs to be sent as the first SS, wherein the priority of each SS in the difference number of SSs has a lower priority than other SS in the SSs corresponding to the DCI that needs to be sent.

Regarding the device in the above embodiment, the specific manner in which each module performs the operation has been described in detail in the embodiment of the relevant method, and will not be elaborated here.

For the device embodiment, since it basically corresponds to the method embodiment, the relevant parts refer to the partial description of the method embodiment. The device embodiment described above is only schematic, wherein the modules described as separate components may or may not be physically separated, and the components displayed as modules may or may not be physical modules, that is, they may be located in one place, or they may be distributed on multiple network modules. Some or all of the modules may be selected according to actual needs to achieve the purpose of the scheme of this embodiment. Those skilled in the art can understand and implement it without paying creative effort.

An embodiment of the present disclosure further provides a communication device, including: a processor; and a memory for storing a computer program; wherein when the computer program is executed by the processor, the downlink control information detection method described in any of the above embodiments is implemented.

An embodiment of the present disclosure further provides a communication device, including: a processor; and a memory for storing a computer program: wherein when the computer program is executed by the processor, the downlink control information sending method described in any of the above embodiments is implemented.

An embodiment of the present disclosure further provides a computer-readable storage medium for storing a computer program. When the computer program is executed by a processor, the steps in the downlink control information detection method described in any of the above embodiments are implemented.

An embodiment of the present disclosure further provides a computer-readable storage medium for storing a computer program. When the computer program is executed by a processor, the steps in the method for sending downlink control information described in any of the above embodiments are implemented.

According to the embodiments of the present disclosure, it is possible to avoid excessive numbers of DCI sizes scrambled by the first RNTI and DCI sizes scrambled by the second RNTI in the same time domain unit, thereby ensuring that the number of blind detections assigned to DCIs of each size will not decrease, ensuring a good parsing effect for DCI, and avoiding affecting the flexibility and performance of physical downlink control channel transmission.

As shown in FIG. 14, FIG. 14 is a schematic block diagram of an apparatus 1400 for sending downlink control information according to an embodiment of the present disclosure. The apparatus 1400 may be provided as a base station. Referring to FIG. 14, the apparatus 1400 includes a processing component 1422, a wireless transmission/reception component 1424, an antenna component 1426, and a signal processing part dedicated to a wireless interface, and the processing component 1422 may further include one or more processors. One of the processors in the processing component 1422 may be configured to implement the downlink control information sending method described in any of the above embodiments.

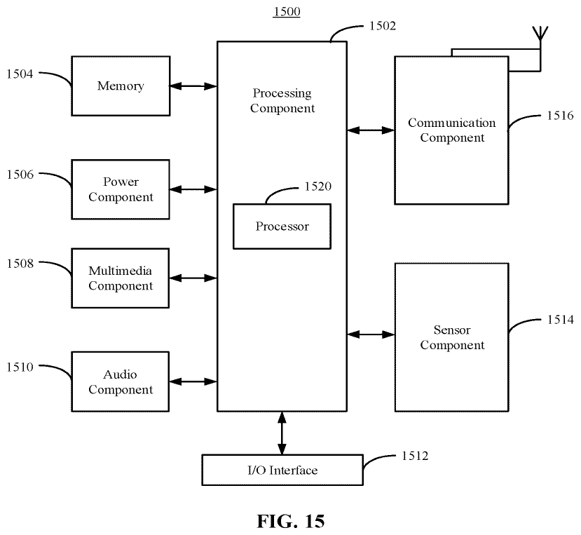

FIG. 15 is a schematic block diagram of a device 1500 for detecting downlink control information according to an embodiment of the present disclosure. For example, the device 1500 may be a mobile phone, a computer, a digital broadcast terminal, a messaging device, a game console, a tablet device, a medical device, a fitness device, a personal digital assistant, etc.

Referring to FIG. 15, the device 1500 may include one or more of the following components: a processing component 1502, a memory 1504, a power supply component 1506, a multimedia component 1508, an audio component 1510, an input/output (I/O) interface 1512, a sensor component 1514, and a communication component 1516.

The processing component 1502 generally controls the overall operations of the device 1500, such as operations associated with display, telephone calls, data communications, camera operations, and recording operations. The processing component 1502 may include one or more processors 1520 to execute instructions to complete all or part of the steps of the above method for detecting DCI. Additionally, processing component 1502 may include one or more modules that facilitate interaction between processing component 1502 and other components. For example, processing component 1502 may include a multimedia module to facilitate interaction between multimedia component 1508 and processing component 1502.

The memory 1504 is configured to store various types of data to support operations at the device 1500. Examples of such data include instructions for any application or method operating on the device 1500, contact data, phonebook data, messages, pictures, videos, etc. The memory 1504 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 1506 provides power to various components of the device 1500. The power component 1506 may include a power management system, one or more power supplies, and other components associated with generating, managing, and distributing power for device 1500.

The multimedia component 1508 includes a screen providing an output interface between the device 1500 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 1508 includes a front camera and/or a rear camera. When the device 1500 is in an operation mode, such as a photographing mode or a video mode, the front camera and/or the rear camera can receive external multimedia data. Each front camera and rear camera can be a fixed optical lens system or have focal length and optical zoom capability.

The audio component 1510 is configured to output and/or input audio signals. For example, the audio component 1510 includes a microphone (MIC), which is configured to receive an external audio signal when the device 1500 is in an operation mode, such as a call mode, a recording mode and a voice recognition mode. Received audio signals may be further stored in memory 1504 or sent via communication component 1516. In some embodiments, the audio component 1510 also includes a speaker for outputting audio signals.

The I/O interface 1512 provides an interface between the processing component 1502 and a peripheral interface module, which may be a keyboard, a click wheel, a button, and the like. These buttons may include, but are not limited to: a home button, volume buttons, start button, and lock button.

The sensor component 1514 includes one or more sensors for providing device 1500 with various aspects of status assessment. For example, the sensor component 1514 can detect the open/closed state of the device 1500, the relative positioning of components, such as the display and the keypad of the device 1500, the sensor component 1514 can also detect the device 1500 or a change in the position of a component of the device 1500, the presence or absence of user's contact with the device 1500, the change of orientation or acceleration/deceleration of the device 1500 and the temperature change of the device 1500. The sensor component 1514 may include a proximity sensor configured to detect the presence of nearby objects in the absence of any physical contact. The sensor component 1514 may also include an optical sensor, such as a CMOS or CCD image sensor, for use in imaging applications. In some embodiments, the sensor component 1514 may also include an acceleration sensor, a gyroscope sensor, a magnetic sensor, a pressure sensor or a temperature sensor.

The communication component 1516 is configured to facilitate wired or wireless communication between the device 1500 and other devices. The device 1500 can access a wireless network based on communication standards, such as Wi-Fi, 2G or 3G, or a combination thereof. In an exemplary embodiment, the communication component 1516 receives broadcast signals or broadcast related information from an external broadcast management system via a broadcast channel. In an exemplary embodiment, the communication component 1516 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, device 1500 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 1504 including instructions, which can be executed by the processor 1520 of the device 1500 to implement the above method for detecting DCI. For example, the non-transitory computer readable storage medium may be ROM, random access memory (RAM), CD-ROM, magnetic tape, floppy disk, and optical data storage device, and the like.

Other embodiments of the disclosure will be readily apparent to those skilled in the art from consideration of the specification and practice of the disclosure disclosed herein. This disclosure is intended to cover any modification, use or adaptation of the present disclosure, these modifications, uses or adaptations follow the general principles of the present disclosure and include common knowledge or conventional technical means in the technical field not disclosed in this disclosure. The specification and examples are to be considered exemplary only, with a true scope and spirit of the disclosure being indicated by the following claims.

It should be understood that the present disclosure is not limited to the precise constructions which have been described above and shown in the accompanying drawings, and various modifications and changes may be made without departing from the scope thereof. The scope of the disclosure is limited only by the appended claims.

It should be noted that, in this disclosure, relational terms such as first and second, etc. are only used to distinguish one entity or operation from another entity or operation, and do not necessarily require or imply any such actual relationship or order between these entities or operations. The terms “include”, “comprises” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the statement “comprises a . . . ” do not exclude the presence of other identical elements in the process, method, article or device including the elements.

The method and device provided in the embodiments of the present disclosure are introduced in detail above. Specific examples are used in this disclosure to illustrate the principles and implementation methods of the present disclosure. The description of the above embodiments is only used to help understand the method of the present disclosure and its core idea. At the same time, for those skilled in the art, according to the idea of the present disclosure, there will be changes in the specific implementation methods and application scopes. In summary, the content of this specification should not be understood as a limitation on the present disclosure.

1. A method for detecting downlink control information, performed by a terminal, and comprising:
not expecting that within a same time domain unit, a number of size of downlink control information DCI scrambled by a first radio network temporary identifier RNTI to be detected is greater than a first number, and a number of size of DCI scrambled by a second RNTI to be detected is greater than a second number;
wherein the DCI at least comprises DCI for scheduling multiple cells.

2. The method according to claim 1, wherein the not expecting that within the same time domain unit, the number of size of downlink control information DCI scrambled by the first radio network temporary identifier RNTI to be detected is greater than the first number, and the number of size of DCI scrambled by the second RNTI to be detected is greater than the second number, comprises:
not expecting to detect a legacy DCI scrambled by the first RNTI and the DCI for scheduling multiple cells within the same time domain unit.

3. The method according to claim 1, wherein the not expecting that within the same time domain unit, the number of size of downlink control information DCI scrambled by the first radio network temporary identifier RNTI to be detected is greater than the first number, and the number of size of DCI scrambled by the second RNTI to be detected is greater than the second number, comprises:
not expecting that within the same time domain unit, a sum of the number of size of legacy DCI scrambled by the first RNTI and the number of size of the DCI for scheduling multiple cells to be detected is greater than the first number, and the number of size of DCI scrambled by the second RNTI to be detected is greater than the second number.

4. The method according to claim 1, wherein the time domain unit comprises at least one of:
a time slot, a time span, or a symbol.

5. The method according to claim 1, wherein the first RNTI comprises at least a cell radio network temporary identifier C-RNTI, and the second RNTI comprises an RNTI other than the C-RNTI.

6. The method according to claim 1, wherein the first number is 3 or 4, and the second number is 1.

7. A method for detecting downlink control information, performed by a terminal, and comprising:
determining that in a same time domain unit, a sum of a number of sizes of DCI for scheduling multiple cells and a number of sizes of DCI scrambled by a first RNTI to be detected is greater than a first number; wherein the DCI at least comprises the DCI for scheduling multiple cells;
determining a first DCI among the DCI to be detected; and
not detecting DCI in a search space corresponding to the first DCI.

8. The method according to claim 7, wherein determining the first DCI among the DCI to be detected comprises:
determining a priority of the DCI to be detected; and
determining the first DCI among the DCI to be detected according to the priority.

9. The method according to claim 8, wherein determining the first DCI among the DCI to be detected according to the priority comprises:
determining a difference between the sum of the number and the first number;
determining a difference number of DCI among the DCI to be detected as the first DCI, wherein the priority of each of the difference number of DCI is lower than the priority of other DCI among the DCI to be detected.

10. The method according to claim 7, wherein determining the first DCI among the DCI to be detected comprises:
determining a priority of a search space SS corresponding to the DCI to be detected; and
determining a first SS among the SS corresponding to the DCI to be detected according to the priority, wherein the DCI corresponding to the first SS is the first DCI.

11. The method according to claim 10, wherein determining the first SS among the SS corresponding to the DCI to be detected according to the priority comprises:
determining a difference between the sum of the number and the first number;
determining a difference number of SS among the SS corresponding to the DCI to be detected as the first SS, wherein the priority of each of the difference number of SS is lower than the priority of other SS among the SS corresponding to the DCI to be detected.

12. The method according to claim 7, wherein the time domain unit comprises at least one of:
a time slot, a time span, or a symbol.

13-17. (canceled)

18. A method for sending downlink control information, performed by a network device, and comprising:
determining that in a same time domain unit, a sum of a number of sizes of DCI for scheduling multiple cells to be sent to a terminal and a number of sizes of DCI scrambled by a first RNTI is greater than a first number; wherein the DCI at least comprises the DCI for scheduling multiple cells;
determining a first DCI among the DCI to be sent; and
not sending DCI in a search space corresponding to the first DCI.

19. The method according to claim 18, wherein determining the first DCI in the DCI to be sent comprises:
determining a priority of the DCI to be sent; and
determining the first DCI among the DCI to be sent according to the priority.

20. The method according to claim 19, wherein determining the first DCI among the DCI to be sent according to the priority comprises:
determining a difference between the sum of the number and the first number;
determining a difference number of DCI among the DCI to be sent as the first DCI, wherein the priority of each of the difference number of DCI is lower than the priority of other DCI among the DCI to be sent.

21. The method according to claim 18, wherein determining the first DCI among the DCI to be sent comprises:
determining a priority of a search space SS corresponding to the DCI to be sent; and
determining a first SS among the SS corresponding to the DCI to be sent according to the priority, wherein the DCI corresponding to the first SS is the first DCI.

22. The method according to claim 21, wherein determining the first SS among the SS corresponding to the DCI to be sent according to the priority comprises:
determining a difference between the sum of the number and the first number;
determining a difference number of SS among the SS corresponding to the DCI to be sent as the first SS, wherein the priority of each of the difference number of SS is lower than the priority of other SS among the SS corresponding to the DCI to be sent.

23-26. (canceled)

27. A communication device, comprising:
a processor; and
a memory for storing a computer program;
wherein when the computer program is executed by the processor, the method for detecting downlink control information according to claim 1 is implemented.

28. A communication device, comprising:
a processor; and
a memory for storing a computer program;
wherein when the computer program is executed by the processor, the method for sending downlink control information according to claim 15 is implemented.

29-30. (canceled)

31. A communication device, comprising:
a processor; and
a memory for storing a computer program;
wherein when the computer program is executed by the processor, the method for sending downlink control information according to claim 18 is implemented.
